(19) United States
(12) Patent Application Publication
(10) Pub. No.: US 2025/0246591 A1
(43) Pub. Date: Jul. 31, 2025

(54) APPARATUS AND METHOD FOR MANUFACTURING SECONDARY BATTERY ELECTRODE PLATES AND ROLLER USED THEREFOR

(71) Applicant: SAMSUNG SDI CO., LTD., Yongin-si, Gyeonggi-do (KR)

(72) Inventors: Giwook Lee, Yongin-si (KR); JUNGHYUN LEE, Yongin-si (KR); Jeongyi Park, Yongin-si (KR); JunHyeok Kwak, Yongin-si (KR); Hyunchul Kim, Yongin-si (KR); Hyemin Park, Yongin-si (KR)

(21) Appl. No.: 18/762,551

(22) Filed: Jul. 2, 2024

(30) Foreign Application Priority Data
Jan. 29, 2024 (KR) 10-2024-0013503

(51) Int. Cl. H01M 4/04; H01M 4/1393

(52) U.S. Cl. CPC H01M 4/0404; H01M 4/0435; H01M 4/1393

(57) ABSTRACT

An apparatus for manufacturing secondary battery electrode plates includes: a coating unit configured to coat an electrode material slurry on a substrate; a rolling unit configured to roll the coated electrode plate; a slitting unit configured to slit the rolled electrode plate in a moving direction of the rolled electrode plate; and a transfer unit comprising a roller in contact with one of the coated electrode plate, the rolled electrode plate, and the slit electrode plate to transfer the corresponding electrode plate. The roller has a first diameter part having a first diameter, a second diameter part having a smaller diameter than the first diameter part, and an inclined part extending between the first diameter part and the second diameter part.

### CROSS-REFERENCE TO RELATED APPLICATION

The present application claims priority to and the benefit of Korean Patent Application No. 10-2024-0013503, filed on Jan. 29, 2024, in the Korean Intellectual Property Office, the entire disclosure of which is incorporated herein by reference.

### BACKGROUND

### 1. Field

Aspects of embodiments of the present disclosure relate to an apparatus and method for manufacturing secondary battery electrode plates and a roller used in the apparatus and method.

### 2. Description of the Related Art

Different from primary batteries, which are not designed to be charged, secondary batteries are designed to be discharged and recharged. Generally, a secondary battery includes an electrode assembly including a positive electrode plate, a negative electrode plate, and a separator, and an enclosure (e.g., a casing or can) accommodating the electrode assembly. The electrode assembly may be classified into a wound electrode assembly or a laminated electrode assembly depending on the type of stacking of the electrode plates and separator. The wound electrode assembly may be in the form of a jelly roll, and the laminated electrode assembly may be in the form of a stack.

The positive and negative electrode plates of the electrode assembly may be manufactured by coating a substrate with a slurry containing an electrode active material, rolling an electrode plate coated with the slurry, and then slitting the rolled electrode plate longitudinally (e.g., in a transfer direction of the electrode plate).

In the process of manufacturing secondary batteries, during a pressing (e.g., rolling) process, an uncoated part and a coated part of the electrode plate may exhibit a difference in elongation due to the difference in height (or thickness) between the uncoated part and the coated part, causing stress in the electrode plate. During a subsequent slitting process, when the electrode plate is slit, the stress may be unevenly distributed due to the reduction in its width, resulting in asymmetric deformation, such as curvature or skew in a slit electrode plate.

This issue may occur not only in the uncoated part and the coated part of the slit electrode plate but also in electrode plates in other processes. In addition, this issue may occur not only in the uncoated part/coated part but also in any electrode plate that includes various parts (or portions) with different thicknesses, such as a thin part (hereinafter, a first thickness part) and a thick part (hereinafter, a second thickness part).

The above information disclosed in this Background section is for enhancement of understanding of the background of the present disclosure, and therefore, it may contain information that does not constitute related (or prior) art.

### SUMMARY

Embodiments of the present disclosure provide an improved roller (including both a drive roller and an idle roller) that transfers a slit electrode plate having a coated part and an uncoated part or an electrode plate having parts with different thicknesses manufactured in other processes. According to embodiments of the present disclosure, deformation of electrodes is alleviated or avoided by making a diameter of a roller portion in contact with a first thickness part or uncoated part of an electrode plate to be larger than a diameter of a roller portion in contact with a second thickness part (that is thicker than the first thickness part) or coated part of the electrode plate and allowing a larger external force to act on the first thickness part or the uncoated part to cause additional elongation of the first thickness part or uncoated part.

According to an embodiment of the present disclosure, an apparatus for manufacturing secondary battery electrode plates includes a coating unit configured to coat an electrode material slurry on a substrate, a rolling unit configured to roll the coated electrode plate, a slitting unit configured to slit the rolled electrode plate in a transfer direction (or moving direction) of the electrode plate, and a transfer unit including a roller in contact with one of the coated electrode plate, the rolled electrode plate, and the slit electrode plate to transfer the corresponding electrode plate. The roller in contact with the electrode plate has a first diameter part having a first diameter, a second diameter part having a smaller diameter than the first diameter part, and an inclined part connecting the first diameter part and the second diameter part.

According to another embodiment of the present disclosure, a method of manufacturing secondary battery electrode plates includes: coating an electrode material slurry on a substrate; rolling the coated electrode plate; slitting the rolled electrode plate in a transfer direction (or moving direction) of the electrode plate, and transferring, by a roller, one of the coated electrode plate, the rolled electrode plate, and the slit electrode plate with the roller in contact with the associated electrode plate. The roller in contact with the electrode plate has a first diameter part having a first diameter, a second diameter part having a smaller diameter than the first diameter part, and an inclined part extending between the first diameter part and the second diameter part. The electrode plate transferred by the roller has a first thickness part that is in contact with the first diameter part of the roller, a second thickness part that is in contact with the second diameter part of the roller and is thicker than the first thickness part, and a boundary part between the first thickness part and the second thickness part that is in contact with the inclined part of the roller.

In some embodiments, the electrode plate transferred by the roller may have a first thickness part that is in contact with the first diameter part of the roller, a second thickness part that is in contact with the second diameter part of the roller and is thicker than the first thickness part, and a boundary part between the first thickness part and the second thickness part that is in contact with the inclined part of the roller. The electrode plate may be the slit electrode plate slit by the slitting unit, the first thickness part may be an uncoated part of the slit electrode plate, and the second thickness part may be a coated part of the slit electrode plate.

In some embodiments, a roller used to manufacture secondary battery electrode plates is provided. The roller is in contact with an electrode plate to transfer the electrode plate. The roller has a first diameter part having a first diameter, a second diameter part having a smaller diameter than the first diameter part, and an inclined part extending between the first diameter part and the second diameter part.

According to embodiments of the present disclosure, a drive roller or an idle roller for transferring the electrode plate has a large diameter part and a small diameter part to position and transfer the electrode plate such that the first thickness part or uncoated part of the electrode plate is in contact with the large diameter part and the second thickness part, which is thicker than the first thickness part, or coated part of the electrode plate is in contact with the small diameter part. Accordingly, deformation of the electrode plate, such as curvature or skew, may be avoided or mitigated by primarily applying pressure to the first thickness part or the uncoated part, the elongation of which is smaller (or less) compared to the coated part, to increase the amount of elongation and reduce the difference in elongation between the first thickness part or the uncoated part and the second thickness part or the coated part. In addition, the roller has an inclined part between the large diameter part and the small diameter part thereof. Accordingly, it is possible to reduce damage to the boundary part between the first thickness part or the uncoated part and the second thickness part or the coated part by allowing the boundary part between the first thickness part or the uncoated part and the second thickness part or the coated part to be in contact with the inclined part.

However, aspects and features of the present disclosure are not limited to those described above, and other aspects and features not mentioned herein will be clearly understood by a person skilled in the art from the detailed description, described below.

### BRIEF DESCRIPTION OF THE DRAWINGS

The following drawings attached hereto illustrate embodiments of the present disclosure and are provided to further describe aspects and features of the present disclosure together with the detailed description of the present disclosure. Thus, the present disclosure should not be construed as being limited to the drawings, in which:

FIG. 1 schematically illustrates an electrode assembly of a secondary battery;

FIG. 2 schematically illustrates a pouch-type secondary battery;

FIG. 3 is a cross-sectional view of a cylindrical secondary battery;

FIG. 4 is a cross-sectional view showing an internal configuration of a prismatic secondary battery;

FIG. 5 is a schematic diagram describing a process of manufacturing an electrode plate of the electrode assembly illustrated in FIG. 1;

FIG. 6 is a schematic diagram illustrating a slitting unit and transfer units for transferring slit electrode plates to rewinders;

FIG. 7 is a view schematically illustrating one slit electrode plate at where a coated layer and an uncoated layer coexist;

FIG. 8 is a perspective view illustrating one roller according to an embodiment of the present disclosure;

FIG. 9 is a view schematically illustrating a state in which the slit electrode plate is transferred by the roller shown in FIG. 8;

FIG. 10 schematically illustrates a state in which a slit electrode plate is transferred by two rollers according to another embodiment of the preset disclosure;

FIG. 11 schematically illustrates a state in which the electrode plate with an insulating layer applied to an uncoated part is transferred by the roller;

FIG. 12 illustrates main dimensions of the shape of the roller shown in FIG. 8;

FIG. 13 is a view of a secondary battery module in which secondary batteries are arranged according to embodiments of the present disclosure;

FIG. 14 is a view of a secondary battery pack including the secondary battery module illustrated in FIG. 13; and

FIG. 15 is a conceptual view illustrating a vehicle equipped with the secondary battery pack illustrated in FIG. 14.

### DETAILED DESCRIPTION

Hereinafter, embodiments of the present disclosure will be described, in detail, with reference to the accompanying drawings. The terms or words used in the present disclosure and claims should be interpreted as having meanings and concepts that are consistent with the technical idea of the present disclosure on the basis of the principle that an inventor can be his/her own lexicographer to appropriately define concepts of terms to describe his/her invention in a suitable way.

The embodiments described in this specification and the configurations shown in the drawings are only some embodiments of the present disclosure and do not represent all of the embodiments of the present disclosure. Accordingly, it should be understood that there may be various equivalents and modifications that can replace or modify one or more embodiments described herein at the time of filing this application.

It will be understood that if an element or layer is referred to as being “on,” “linked to”, “connected to,” or “coupled to” another element or layer, it may be directly on, linked to, connected, or coupled to the other element or layer or one or more intervening elements or layers may also be present. When an element or layer is referred to as being “directly on”, “directly linked on”, “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a comparison having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or provided in a plurality.

Arranging an arbitrary element “above (or below)” or “on (or under)” another element may mean that the arbitrary element may contact the upper (or lower) surface of the element, and another element may be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

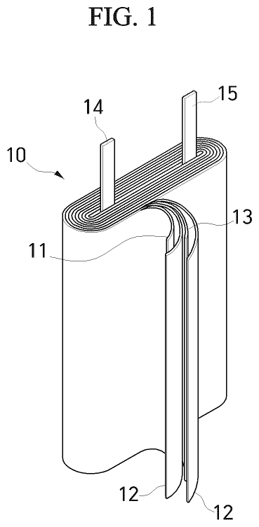

FIG. 1 shows an electrode assembly of a secondary battery.

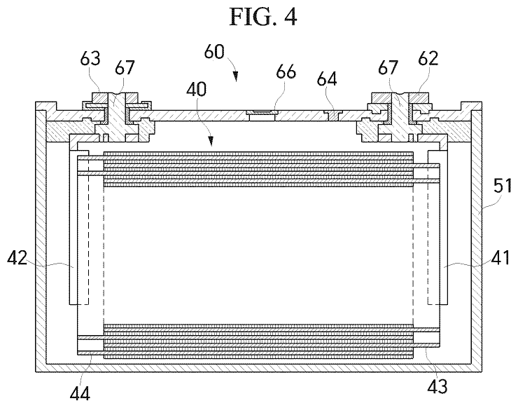

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction of the case 51 (see, e.g., FIG. 4). In other embodiments, the electrode assembly 10 may be a stack type rather than a winding type, but the shape of the electrode assembly 10 is not limited in the present disclosure. In addition, the electrode assembly 10 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate 11 of the electrode assembly 10 may act as a negative electrode, and the second electrode plate 13 may act as a positive electrode. Of course, the reverse is also possible.

The first electrode plate 11 may be formed by applying a first electrode active material, such as graphite or carbon, to a first electrode current collector formed of a metal foil, such as copper, a copper alloy, nickel, or a nickel alloy. The first electrode plate 11 may include a first electrode tab 14 (e.g., a first uncoated portion) that is a region to which the first electrode active material is not applied. The first electrode tab 14 may be connected to an external first terminal. In some embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than (e.g., farther than or beyond) the separator 12 without being separately cut.

The second electrode plate 13 may be formed by applying a second electrode active material, such as a transition metal oxide, on a second electrode current collector formed of a metal foil, such as aluminum or an aluminum alloy. The second electrode plate 13 may include a second electrode tab 15 (e.g., a second uncoated portion) that is a region to which the second electrode active material is not applied. The second electrode tab 15 may be connected to an external second terminal. In some embodiments, the second electrode tab 15 may be formed by being cut in advance to protrude to the one side of the electrode assembly 10 when the second electrode plate 13 is manufactured, or the second electrode plate 13 may protrude to the one side of the electrode assembly more than (e.g., farther than or beyond) the separator 12 without being separately cut.

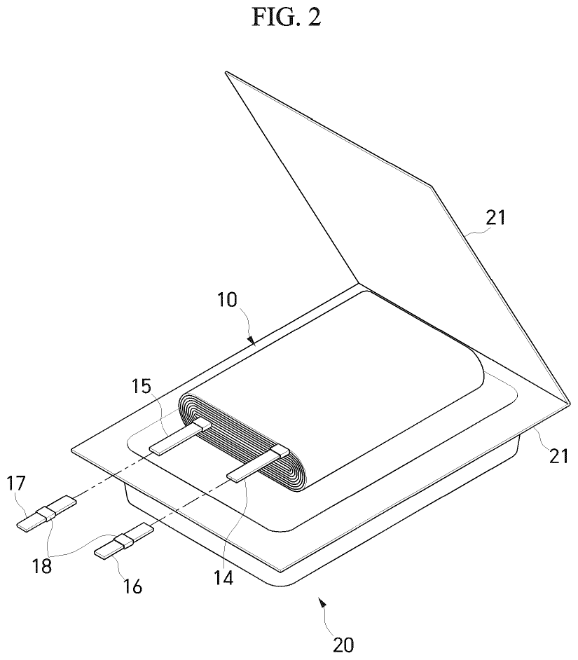

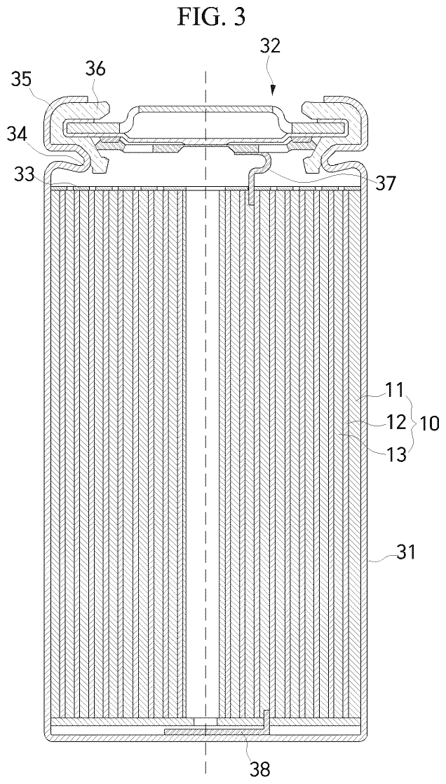

In some embodiments, the first electrode tab 14 and the second electrode tab 15 may be located on opposite sides of the electrode assembly 10 (see, e.g., FIGS. 3 and 4). In other embodiments, the first electrode tab 14 and the second electrode tab 15 may be located on one side of the electrode assembly 10 in the same direction (see, e.g., FIGS. 1 and 2).

For convenience of description, the left and right sides are defined according to the electrode assembly 10 as oriented in FIG. 1, and the positions thereof may change when the secondary battery is rotated left and right or up and down.

The separator 12 prevents a short-circuit between the first electrode 11 and the second electrode 13 while allowing for movement of lithium ions therebetween. The separator 12 may be made of, for example, a polyethylene film, a polypropylene film, a polyethylene-polypropylene film, or the like.

In some embodiments, the electrode assembly 10 may be accommodated in a case along with an electrolyte.

In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

FIG. 2 schematically illustrates the pouch-type secondary battery.

The pouch-type secondary battery includes an electrode assembly 10 and a pouch 20 accommodating the electrode assembly 10.

The electrode assembly 10 is the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with (e.g., covered by) a tab film 18 for insulation from the pouch 20.

The pouch 20 may be sealed by having sealing parts 21 at the edges thereof which contact each other while accommodating the electrode assembly 10 and with the tab film 18 interposed between the sealing parts 21. The sealing parts 21 of the pouch 20 may each be made of a thermal fusion material that generally has weak adhesion to metal. Thus, the first electrode tab 14 and the second electrode tab 15 may be fused to the pouch 20 by interposing the thin tab 18 between the sealing parts 21.

FIG. 3 illustrates a cylindrical secondary battery. Referring to FIG. 3, a secondary battery may include an electrode assembly 10, a case 31 accommodating the electrode assembly 10 and an electrolyte therein, a cap assembly 32 coupled to an opening in the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 32, forms the external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of a gasket 36 and the cap assembly 32. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by the gasket 36 to seal the case 31.

A first lead tab 37 drawn out from (e.g., extending from) the electrode assembly 10 may be connected to the cap assembly 32, and a second lead tab 38 drawn out from (e.g., extending from) the electrode assembly 10 may be electrically connected to the bottom of the casing 31.

FIG. 4 shows the internal structure of a prismatic secondary battery.

As shown in FIG. 4, a prismatic secondary battery may include an electrode assembly 40, a first current collector 41, a first terminal 62, a second current collector 42, a second terminal 63, a case 51, and a cap assembly 60.

The electrode assembly 40 may be formed by winding or stacking a stack of a first electrode plate, a separator, and a second electrode plate, which are formed as thin plates or films. If the electrode assembly 40 is a wound stack, a winding axis may be parallel to the longitudinal direction of the case 51. In other embodiments, the electrode assembly 40 may be a stack type rather than a winding type, but the shape of the electrode assembly 40 is not limited in the present disclosure. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As mentioned above, in some embodiments in which the first electrode tab 43 and the second electrode tab 44 are located at the top of the electrode assembly 40, the first and second current collectors would be located at the top of the electrode assembly 40.

As illustrated in FIG. 4, the first current collector 41 and the second current collector 42 are connected to the first terminal 62 and the second terminal 63 through connection members 67, respectively. In some embodiments, the connection members 67 may each have an outer peripheral surface that is threaded and may be fastened to the first terminal 62 and the second terminal 63 by screwing. However, the present disclosure is not limited thereto. For example, the connection members 67 may also be coupled to the first terminal 62 and the second terminal 63 by riveting or welding.

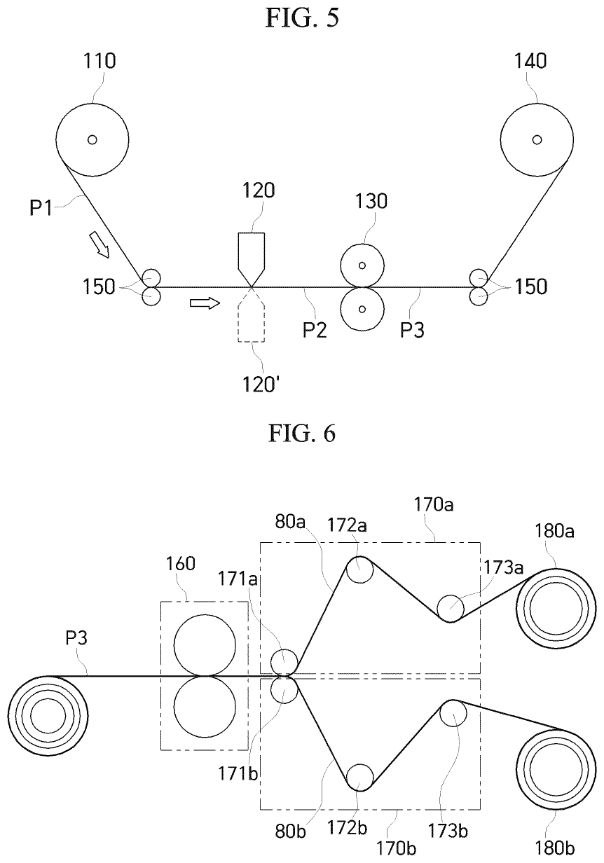

FIG. 5 is a schematic diagram describing a process for manufacturing an electrode plate (e.g., the first electrode plate 11 or the second electrode plate 13) of the electrode assembly 10 illustrated in FIG. 1.

A supply roll 110 is a roll on which a substrate P1 for an electrode plate is wound. When an apparatus for manufacturing electrode plates, according to an embodiment of the present disclosure, is used to manufacture a positive electrode plate, the substrate P1 may be a metal foil containing aluminum (Al), for example. When the apparatus for manufacturing electrode plates, according to an embodiment of the present disclosure, is used to manufacture a negative electrode plate, the substrate P1 may be a metal foil containing copper (Cu) or nickel (Ni).

A transfer roller 150 may be an idle roller that guides the substrate P1 after it is unwounded from the supply roll 110 or a drive roller that applies a pulling force to allow the substrate P1 to be unwound from the supply roll 110. FIG. 5 illustrates an embodiment including a total of four transfer rollers 150 as an example, but the number and positions of transfer rollers may be varied.

A coating unit 120 forms a coating layer by coating the substrate P1 with an electrode material slurry that is previously prepared. The slurry contains an active material. When the apparatus for is used to manufacture the positive electrode plate, the slurry may be prepared with an active material containing a transition metal oxide, a binder, a volatile solvent, and the like, for example. When the apparatus is used to manufacture the negative electrode plate, the slurry may be prepared with an active material containing a transition metal oxide, a binder, a solvent, or the like. Moreover, both surfaces (e.g. the upper and lower surfaces) of the substrate P1 may be coated concurrently (or simultaneously) by adding a second coating unit 120′, which may have the same configuration as the coating unit 120, to the lower surface of the substrate P1.

A rolling unit (e.g., a roll-pressing unit) 130 uses pressing rollers to compresses an electrode plate P2 coated with the slurry (mixture) by the coating unit 120 to produce a high-capacity and high-density secondary battery.

A winding roll 140 is a roll that winds and accommodates an electrode plate P3 coated and rolled by the coating unit 120 and the rolling unit 130.

A drying unit may be added between the coating unit 120 and the winding roll 140 to dry or solidify the electrode plate P2 coated with the slurry. The drying unit may include a heating device. In addition, the drying unit may be physically separated from or otherwise functionally integrated into the rolling unit 130. For example, when the rolling unit 130 is configured in the form of a roller, the roller may be equipped with a heating device to concurrently (or simultaneously) heat and roll the coating layer, thereby allowing the rolling unit 130 to be configured to also act as a drying unit.

FIG. 6 is a schematic diagram illustrating a slitting unit 160 that slits the electrode plate P3 rolled by the rolling unit 130 and wound on the winding roll 140, as shown in FIG. 5, longitudinally (e.g., in a moving direction of the electrode plate) and transfer units 170a and 170b for transferring slit electrode plates 80a and 80b to respective rewinders 180a and 180b.

Two electrode plates 80a and 80b, which are slit (e.g., cut in the longitudinal direction of the electrode plate, that is, in the moving direction of the electrode plate) and separated by the slitting unit 160 and may be transferred to and rewound on the rewinders 180a and 180b through a plurality of rollers 171a to 173a and 171b to 173b included in the transfer units 170a and 170b, respectively.

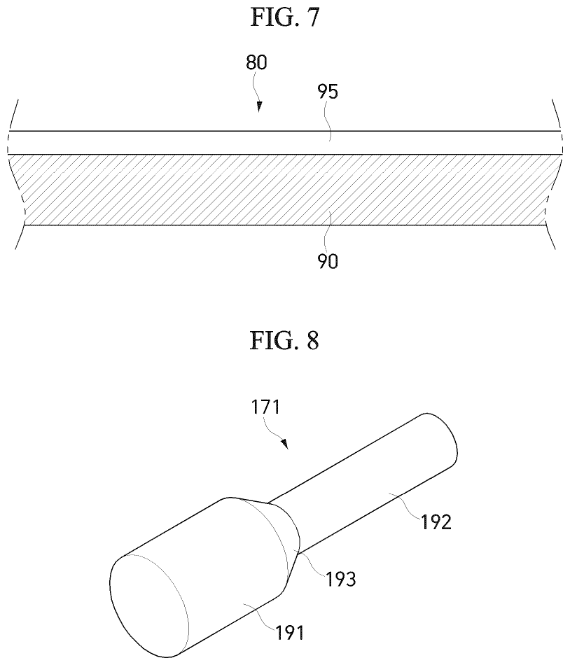

The slitting unit 160 slits the electrode plate P3, which is coated and rolled in the process described with reference to FIG. 5, along a line of cutting plane parallel to the direction of transfer to separate the electrode plate P3 into individual rows. When subjecting to this slitting process, a slit electrode plate 80 may be obtained in the form of a strip where there coexist (e.g., having both) a coated part 90 having a second thickness with a coating layer formed thereon and an uncoated part 95 having a first thickness smaller than the second thickness with no coating layer formed thereon, as illustrated in FIG. 7.

The slitting unit 160, the transfer units 170a and 170b, and the rewinders 180a and 180b may be arranged in a continuous line behind (or after) the rolling unit 130 shown in FIG. 5 or may be organized into a separate production line, as illustrated in FIG. 6. In the latter embodiment, the electrode plate P3 obtained by rolling the coated electrode plate P2 through the production line illustrated in FIG. 5 may be wound on the winding roll 140 and transferred to the separately organized slitting line as illustrated in FIG. 6. Then, in the slitting line, the electrode plate P3 may be unwound from the winding roll 140 and slit in the direction of transfer of the electrode plate P3 by the slitting unit 160.

Because the part rolled by the rolling unit 130 is primarily the thick coated part, a difference in elongation may occur between the coated part and the uncoated part due to a greater amount of elongation by rolling in the coated part than in the uncoated part. In this case, the electrode plate does not deform because the electrode plate has a relatively large width before slitting and the stress generated due to the difference in elongation is distributed on (or through) the electrode plate. However, deformation of the electrode plate, such as curvature or a skew, may be occur in the electrode plate 80 that is slit through the slitting process because it has a small width and the stress generated due to the difference in elongation between the coated part 90 and the uncoated part 95 is not smoothly (or evenly) distributed on (or through) the electrode plate as illustrated in FIG. 7. If the electrode plate 80 is continuously deformed, the electrode plate 80 may break during the subsequent process of assembly, such as winding or notching.

To reduce or minimize electrode deformation, a method to increase ductility (weakening tensile strength) by applying induction heat annealing (IHA) may be applied to the uncoated part 95 to increase the amount of elongation of the uncoated part in the pressing process. However, because the degree of compression in the rolling process increases and the difference in elongation between the coated part 90 and the uncoated part 95 increases with the trend of producing electrodes with high energy density, there is a need for an additional (or alternative) method of reducing electrode deformation.

FIG. 8 illustrates one roller 171 from among the plurality of rollers included in the transfer units 170a and 170b according to embodiments of the present disclosure. This roller 171 may be a drive roller or an idle roller. The roller 171, according to embodiments of the present disclosure, may include two parts having different diameters, for example, a large diameter part 191 and a small diameter part 192 with an inclined part 193 extending between the large diameter part 191 and the small diameter part 192. Hereinafter, the large diameter part 191 will be referred to as a first diameter part, and the small diameter part 192 will be referred to as a second diameter part. The second diameter part 192 has a smaller diameter than the first diameter part 191.

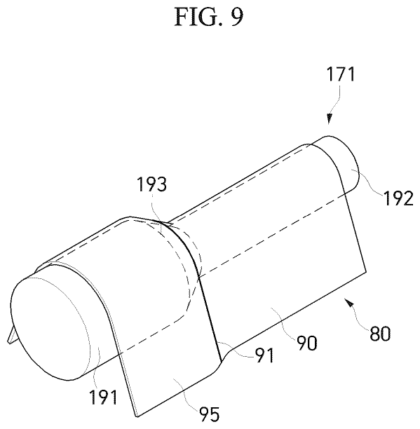

FIG. 9 is a view schematically illustrating a state in which the slit electrode plate 80 is transferred by the roller 171. The following embodiment will be described in the context of alleviating or preventing deformation, such as curvature or skew, of the slit electrode plate 80 including the coated part 90 and the uncoated part 95, but the aspects and features of the present disclosure are not limited thereto. For example, the electrode plate may refer o electrode plates manufactured through other processes, such as coating, pressing, and drying, as well as the slit electrode plate 80, and may also include an electrode plate having portions with different thicknesses as well as the electrode plate including the uncoated part and the coated part.

When the electrode plate 80 is transferred by the roller 171, the electrode plate 80 may be positioned such that the uncoated part 95 is in contact with the first diameter part 191, the coated part 90 is in contact with the second diameter part 192, and the boundary part 91 between the uncoated part 95 and the coated part 90 is in contact with the inclined part 193. Because the uncoated part 95 is transferred in contact with the first diameter part 191, pressure is primarily applied to the uncoated part 95, the elongation of which is less compared to the coated part 90, thereby generating additional elongation. Thus, the difference in elongation between the uncoated part 95 and the coated part 90 may be reduced such that deformation of the electrode plate 80, such as curvature or skew, can be reduced or avoided.

The boundary part 91 between the coated part 90 and the uncoated part 95 is located on the inclined part 193, which has a diameter that gradually decreases between the first diameter part 191 and the second diameter part 192 of the roller 171, which may alleviate pressure applied to and bending at the boundary part 91 between the coated part 90 and the uncoated part 95. Therefore, damage to the electrode plate may be prevented. Because the inclined part 193 has a tapered diameter, the boundary part 91 between the coated part 90 and the uncoated part 95 does not necessarily have to coincide (or exactly coincide) with the starting point of the inclined part 193.

In some embodiments, the roller 171 may be manufactured such that the friction force between the uncoated part 95 of the electrode plate 80 and the first diameter part 191 of the roller 171 is different from the friction force between the coated part 90 and the second diameter part 192. For example, the first diameter part 191 and the second diameter part 192 may be formed (or processed) such that a surface friction force of the second diameter part 192 in contact with the coated part 90 is greater than a surface friction force of the first diameter part 191 in contact with the uncoated part 95. This difference in frictional force can prevent the electrode plate 80 from slipping due to the difference in pressure applied to the coated part 90 and the uncoated part 95 by the different diameters of the first diameter part 191 and the second diameter part 192 when the electrode plate 80 is transferred by the roller 171.

According to embodiments, to provide a friction force between the first diameter part 191 and the uncoated part 95 that is different than a friction force between the second diameter part 192 and the coated part 90, the surface roughness of the first diameter part 191 may be different from that of the second diameter part 192. For example, the surface of the second diameter part 192 may be processed to be rougher than the surface of the first diameter part 191.

According to another embodiment, to provide a friction force between the first diameter part 191 and the uncoated part 95 that is different from a friction force between the second diameter part 192 and the coated part 90, the first diameter part 191 and the second diameter part 192 may be made of different materials. For example, the second diameter part 192 may be made of a material with a higher friction force, and the first diameter part 191 may be made of a material with a relatively low friction force.

According to another embodiment, to provide a friction force between the first diameter part 191 and the uncoated part 95 that is different from a friction force between the second diameter part 192 and the coated part 90, coating layers with different friction forces may be formed on the first diameter part 191 and the second diameter part 192. For example, a coating layer with a higher friction force may be formed on the second diameter part 192, and a coating layer with a relatively low friction force may be formed on the first diameter part 191.

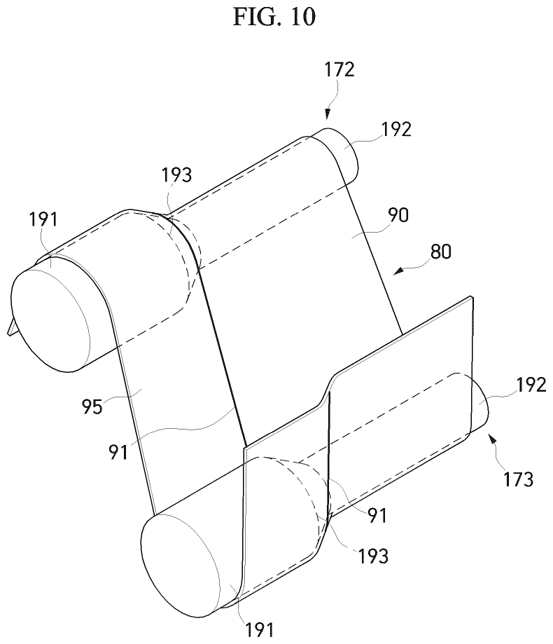

FIG. 10 schematically illustrates a state in which an electrode plate 80 is transferred by (or between) two rollers 172 and 173. To avoid problems, such as an insufficient amount of elongation of the uncoated part 95 or bending of the electrode plate 80 to only one side when the electrode plate 80 is transferred by one roller 171 in the embodiment shown in FIG. 9, a plurality of rollers 172 and 173 may be used, each having the same shape as illustrated in FIG. 8.

When two or more rollers are used as shown in FIG. 10, the different surfaces (e.g., opposite surfaces) of the electrode plate 80 may be in contact with the respective rollers. For example, the electrode plate 80 may be transferred with the first surface thereof in contact with the first roller 172 and the second surface thereof in contact with the second roller 173. This arrangement can prevent or avoid bending of the electrode plate 80 to only one side. In addition, because the electrode plate 80 is transferred by the two rollers 172 and 173, the amount of elongation of the uncoated part 95 may be doubled.

In the process of coating the electrode plate (see, e.g., FIG. 5), an insulating part (or an insulating layer) may sometimes be formed by applying an insulating layer to some regions of the uncoated part. The insulating part may be formed longitudinally having a width (e.g., a predetermined width) at the boundary between the uncoated part and the coated part. The insulating part may have a third thickness that is equal to or different from the thickness of the uncoated part and the coated part.

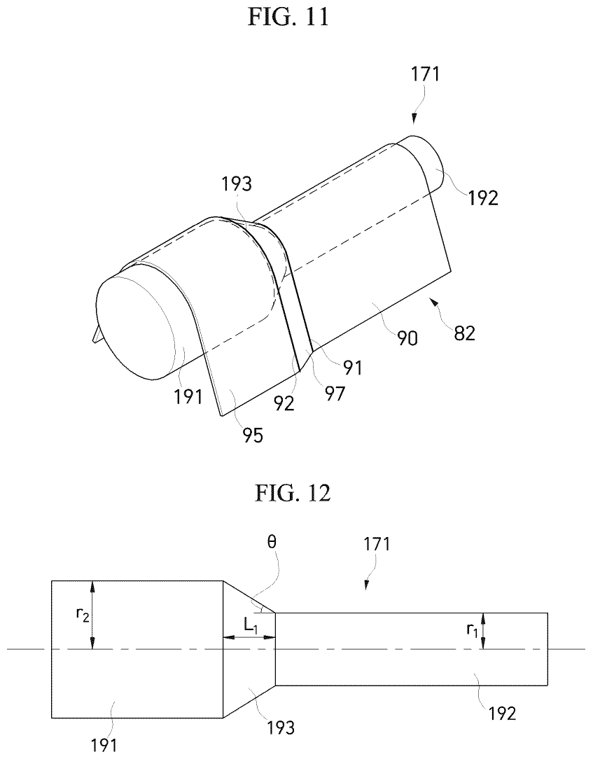

FIG. 11 illustrates a state in which an electrode plate 82 with an insulating part 97 formed on an uncoated part 95 is transferred by the roller 171 according to an embodiment of the present disclosure. The insulating part 97 is formed with a width on (or over) the uncoated part 95 of the electrode plate 82. A boundary part 91 between the coated part 90 and the uncoated part 95 and a boundary part 92 between the uncoated part 95 and the insulating part 97 are illustrated.

In this electrode plate 82, the insulating part 97 may be located on (e.g., arranged on) the inclined part 193 of the roller 171. The boundary part 91 between the coated part 90 and the uncoated part 95 and a boundary part 92 between the uncoated part 95 and the insulating part 97 may be located at least at the starting and ending points of the inclined part 193.

FIG. 12 illustrates dimensions defining a shape of each roller 171, 172, or 173 according to embodiments of the present disclosure. In FIG. 12, r₁ refers to a radius of the second diameter part 192, r₂ refers to a radius of the first diameter part 191, L₁ refers to a length of the inclined part 193, and 6 refers to an angle of inclination of the inclined part 193 (e.g., an angle with respect to the longitudinal outer surface of the first or second diameter part 191 or 192).

The roller 171 may be designed having the main dimensions defining the shape thereof in consideration of various factors. The factors to be considered may include whether or not the coating of the electrode plate is a single-sided coating or a double-sided coating. In addition, the insulating part 97 that may be added to a portion of the width of the uncoated part 95, as described above, may be one of the factors to be considered when designing the roller 171.

The following Table 1 shows experimental data conducted by the inventor to obtain the basis for designing the shape of the roller 171. The improvement rate of curvature or skew of the electrode plate 80 was calculated by changing the presence or absence of the insulating part 97, the angle of the inclined part 193, and the length of the inclined part 193. The improvement rate of curvature or skew m may be calculated by using the following Equation. In the Equation below, m₁ is a curvature or skew value of the existing electrode plate, and m₂ is a curvature or skew value of the electrode plate when applying the shape of the roller according to embodiments of the present disclosure:

$$m ( \% ) = \frac{{m}_{1} - {m}_{2}}{{m}_{1}} \times 100$$

TABLE 1

| PRESENCE/ABSENCE | ANGLE OF | LENGTH OF | IMPROVEMENT | | |
|---|---|---|---|---|---|
| OF INSULATING | INCLINATION | INCLINED PART | RATE | | |
| LAYER | θ(°) | L1(mm) | CURVATURE | SKEW | NOTE |
| X | 1 | 3 | −19.3 | −58.8 | CURVATURE/ |
| | | | | | SKEW |
| | | | | | INTENSIFIED |
| X | 5 | 3 | 40.0 | 30.9 | |
| ◯ | 1 | 1.5 | −54.0 | 16.9 | ONLY SKEW |
| | | | | | IMPROVED |
| ◯ | 2 | 1.5 | 34.1 | 40.2 | |
| ◯ | 3 | 1.5 | 40.0 | 45.4 | |
| ◯ | 10 | 1.5 | 56.0 | 65.2 | |
| ◯ | 15 | 1.5 | 72.0 | 72.5 | |
| ◯ | 25 | 1.5 | 84.0 | 84.1 | BREAKAGE |
| | | | | | OCCURS |
| ◯ | 20 | 1 | 93.3 | 93.1 | |
| ◯ | 10 | 1 | 94.3 | 64.9 | |

In the result of experiment, in the case of the electrode plate 80 without the insulating part 97, the improvement rate of curvature was 40.0% and the improvement rate of skew was 30.9% when L₁ was 3 mm and θ was 5°, and the curvature and the skew were intensified when θ was 1°.

In the case of the electrode plate 82 with the insulating part 97, when L₁ was 1.5 mm, the improvement rate of curvature and skew generally increased as θ was increased. However, the curvature was intensified and only the skew was improved when θ was 1°, and the electrode plate 82 was broken during transfer when θ was 25° (that is, when the difference between the first diameter part 191 and the second diameter part 192 was relatively large). After the breakage occurred, L₁ was changed to 1 mm. Accordingly, the improvement rates of curvature and skew were 93.3% and 93.1%, respectively, when θ was 20°, and the improvement rates of curvature and skew were 94.3% and 64.9%, respectively, when θ was 10°.

Based on this experimental data, the shape of each roller 171, 172, or 173 can be designed according to embodiments of the present disclosure as follows.
1) The range of the angle θ formed by the inclined part 193 is in a range of about 5°≤θ≤about 20°.

In such an embodiment, the narrower the electrode plate width, the greater the angle of inclination can be applied to reduce damage to the electrode plate. In addition, if an angle smaller than the above range is used, the effect of improving curvature and skew may be reduced due to the reduction in the amount of elongation by the roller. On the other hand, if a higher angle is used, damage to the uncoated part may be intensified, resulting in severe waves or breakage during transfer of the electrode plate.
2) The length L₁ of the inclined part 193 is in a range of about 1 mm L₁ about 3 mm.
3) The difference between the radius r₂ of the first diameter part 191 and the radius r₁ of the second diameter part 192 is about 100 μm≤(r₂−r₁)≤about 350 μm. If the range of this difference in radius is subdivided according to the single-sided coating and double-sided coating of the electrode plate, the roller transferring the double-sided coated electrode plate should exhibit about 150 μm≤(r₂−r₁)≤about 350 μm, and the roller transferring the single-sided coated electrode plate should exhibit about 100 μm≤(r₂−r₁)≤about 300 μm. Because the double-sided coated electrode plate is thicker than the single-sided coated electrode plate, r₂−r₁ is larger in the former embodiment.

Hereinafter, material(s) that may be usable for the secondary battery according to the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}XbO_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤α<2); LiₐNi_{1-b-c}Mn_{b}X_{c}O_{2-α}Dα (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); or LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of about 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al), but it is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one or more embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. If an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

If a carbonate-based solvent is used, a mixture of cyclic carbonate and chain carbonate may be used.

Depending on the type of lithium secondary battery, a separator may be present between (e.g., arranged between) the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

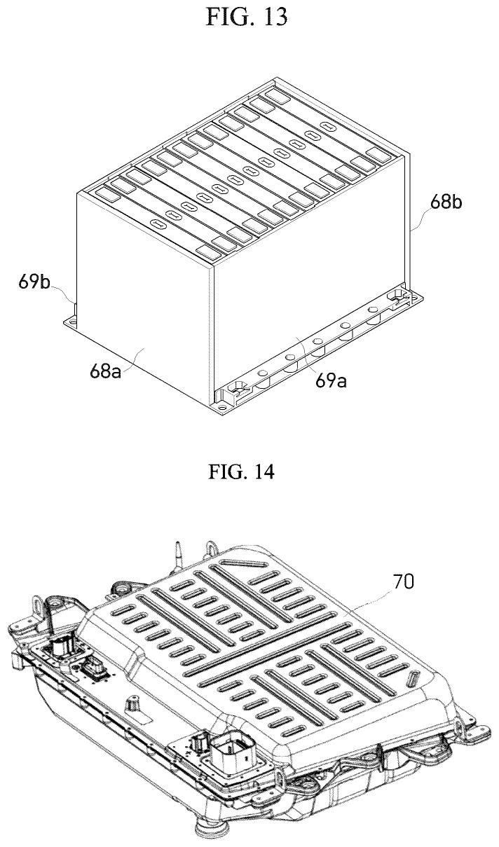

FIG. 13 is a view of a secondary battery module in which prismatic secondary batteries are arranged according to embodiments of the present disclosure. With the increase in secondary battery capacity for driving electric vehicles and the like, a secondary battery module may be manufactured by arranging a plurality of secondary battery cells transversely and/or longitudinally and connecting them together. The plurality of secondary batteries may be arranged in a space defined by a pair of facing/opposite end plates 68a and 68b and a pair of facing/opposite side plates 69a and 69b. The secondary batteries may be provided and configured in both arrangement (e.g., direction) and number to provide desired voltage and current specifications.

FIG. 14 is a view schematically showing the configuration of a battery pack 70 according to embodiments of the present disclosure. Referring to FIG. 14, a battery pack 70 may include an assembly to which individual batteries are electrically connected and a pack housing accommodating the same. In the drawings, for convenience of illustration, some components including a bus bar, a cooling unit, external terminals for electrically connecting batteries, etc., are omitted.

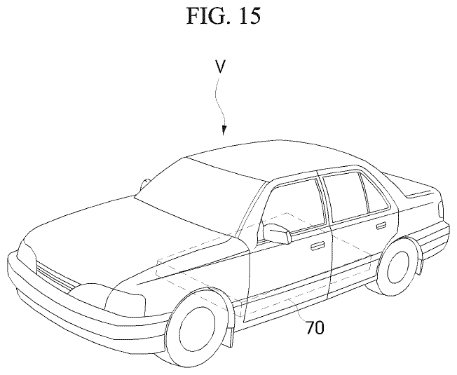

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 15 shows a vehicle V according to embodiments of the present disclosure including the battery pack 70 shown in FIG. 14 on the lower body thereof. The vehicle V may operate by (e.g., may be powered by) receiving power from the battery pack 70.

Although the present disclosure has been described above with respect to embodiments thereof, the present disclosure is not limited thereto. Various modifications and variations can be made thereto by those skilled in the art within the spirit of the present disclosure and the equivalent scope of the appended claims, with equivalents thereof to be included therein.

What is claimed is:

1. An apparatus for manufacturing secondary battery electrode plates, the apparatus comprising:
a coating unit configured to coat an electrode material slurry on a substrate;
a rolling unit configured to roll the coated electrode plate;
a slitting unit configured to slit the rolled electrode plate in a moving direction of the rolled electrode plate; and
a transfer unit comprising a roller in contact with one of the coated electrode plate, the rolled electrode plate, and the slit electrode plate to transfer the corresponding electrode plate,
wherein the roller has a first diameter part having a first diameter, a second diameter part having a smaller diameter than the first diameter part, and an inclined part extending between the first diameter part and the second diameter part.

2. The apparatus according to claim 1, wherein the electrode plate transferred by the roller has a first thickness part and a second thickness part that is thicker than the first thickness part, and
wherein the electrode plate is configured such that the first thickness part is in contact with the first diameter part of the roller, the second thickness part is in contact with the second diameter part of the roller, and a boundary part between the first thickness part and the second thickness part is in contact with the inclined part.

3. The apparatus according to claim 2, wherein the electrode plate transferred by the roller is the slit electrode plate slit by the slitting unit,
wherein the first thickness part is an uncoated part of the electrode plate, and
wherein the second thickness part is a coated part of the electrode plate.

4. The apparatus according to claim 1, wherein the electrode plate transferred by the roller has a first thickness part, a second thickness part that is thicker than the first thickness part, and a third thickness part between the first thickness part and the second thickness part, and
wherein the electrode plate is configured such that the first thickness part is in contact with the first diameter part of the roller, the second thickness part is in contact with the second diameter part of the roller, and the third thickness part is in contact with the inclined part of the roller.

5. The apparatus according to claim 4, wherein the electrode plate transferred by the roller is the slit electrode plate slit by the slitting unit,
wherein the first thickness part is an uncoated part of the electrode plate,
wherein the second thickness part is a coated part of the electrode plate, and
wherein the third thickness part is an insulating part of the electrode plate.

6. The apparatus according to claim 1, wherein the inclined part of the roller has an angle of inclination in a range from 5° to 20°.

7. The apparatus according to claim 1, wherein the inclined part of the roller has a length in a range from 1 mm to 3 mm.

8. The apparatus according to claim 1, wherein a difference between radii of the first and second diameter parts of the roller is in a range from 100 μm to 350 μm.

9. The apparatus according to claim 1, wherein the first and second diameter parts of the roller have different surface roughnesses.

10. The apparatus according to claim 1, wherein a friction force between the first diameter part of the roller and the electrode plate in contact therewith is different from a friction force between the second diameter part of the roller and the electrode plate in contact therewith.

11. A roller to manufacture secondary battery electrode plates, the roller being in contact with an electrode plate to transfer the electrode plate during manufacturing of secondary batteries, the roller comprising:
a first diameter part having a first diameter;
a second diameter part having a smaller diameter than the first diameter part; and
an inclined part extending between the first diameter part and the second diameter part.

12. The roller according to claim 11, wherein the inclined part of the roller has an angle of inclination in a range from 5° to 20°.

13. The roller according to claim 11, wherein the inclined part of the roller has a length in a range from 1 mm to 3 mm.

14. The roller according to claim 11, wherein a difference between radii of the first and second diameter parts of the roller is in a range from 100 μm to 350 μm.

15. The roller according to claim 11, wherein the first and second diameter parts of the roller have different surface roughnesses.

16. A method of manufacturing secondary battery electrode plates, the method comprising:
coating an electrode material slurry on an electrode plate substrate;
rolling the coated electrode plate;
slitting the rolled electrode plate in a moving direction of the electrode plate; and
transferring, by a roller, one of the coated electrode plate, the rolled electrode plate, and the slit electrode plate with the roller in contact with the corresponding electrode plate,
wherein the roller in contact with the electrode plate has a first diameter part having a first diameter, a second diameter part having a smaller diameter than the first diameter part, and an inclined part extending between the first diameter part and the second diameter part, and
wherein the electrode plate transferred by the roller has a first thickness part that is in contact with the first diameter part of the roller, a second thickness part that is in contact with the second diameter part of the roller and is thicker than the first thickness part, and a boundary part between the first thickness part and the second thickness part that is in contact with the inclined part of the roller.

17. The method according to claim 16, wherein the electrode plate transferred by the roller is the slit electrode plate formed by the slitting of the rolled electrode plate,
wherein the first thickness part is an uncoated part of the slit electrode plate, and
wherein the second thickness part is a coated part of the slit electrode plate.

18. The method according to claim 16, wherein the electrode plate transferred by the roller has a third thickness part between the first thickness part and the second thickness part, and
wherein the electrode plate is configured such that the first thickness part is in contact with the first diameter part of the roller, the second thickness part is in contact with the second diameter part of the roller, and the third thickness part is in contact with the inclined part of the roller.

19. The method according to claim 18, wherein the electrode plate transferred by the roller is the slit electrode plate formed by the slitting of the rolled electrode plate,
wherein the first thickness part is an uncoated part of the slit electrode plate,
wherein the second thickness part is a coated part of the slit electrode plate, and
wherein the third thickness part is an insulating part of the slit electrode plate.

20. The method according to claim 16, wherein a friction force between the first diameter part of the roller and the electrode plate in contact therewith is different from a friction force between the second diameter part of the roller and the electrode plate in contact therewith.
